(19) United States
(12) Patent Application Publication
(10) Pub. No.: US 2024/0193697 A1
(43) Pub. Date: Jun. 13, 2024

(54) INTELLIGENT BEST DRIVER RECOMMENDATION ASSISTANT FOR BETTER RENTAL AND INSURANCE RATES

(71) Applicant: INTERNATIONAL BUSINESS MACHINES CORPORATION, ARMONK, NY (US)

(72) Inventors: Hamid Majdabadi, OTTAWA (CA); Jeremy R. Fox, Georgetown, TX (US); Peng Hui Jiang, Beijing (CN); Su Liu, Austin, TX (US)

(21) Appl. No.: 18/078,158

(22) Filed: Dec. 9, 2022

(51) Int. Cl. G06Q 40/08

(52) U.S. Cl. CPC G06Q 40/08

(57) ABSTRACT

A computer-implemented method for recommending a best driver to get best vehicle rental and insurance costs. The method builds a framework of a group of multiple driving candidates to select from to be a driver of a rental vehicle. The method further determines a driving score based on the collected set of data and generates an aggregate ranking of each of the multiple driving candidates based on the driving score. The method further computes an insurance cost for each of the multiple driving candidates based on the driving score and calculates a vehicle rental and insurance cost for each of the multiple driving candidates, based on the driving score. The method further ranks each of the multiple driving candidates based on the respective calculated vehicle rental cost and insurance cost and recommends a highest ranked candidate as the best driver to receive the best vehicle rental and insurance costs.

### BACKGROUND

The present disclosure relates generally to the field of cognitive computing, Internet of Things (IoT), and more particularly to data processing and determining a best driver in a group of drivers for best rental and insurance rates.

The car rental and car-sharing market is expected to grow in the coming years as many people have cancelled their car insurance due to the prevalence of remote working arrangements.

Currently, car insurance rates are expensive and static. People are looking for more flexible insurance rates.

In the ride-sharing business, there is no efficient way to determine a best driver from a group of people and then assign a car to the best driver with a discounted insurance rate.

### BRIEF SUMMARY

Embodiments of the present invention disclose a method, a computer program product, and a system, for efficiently determining a best driver in a grouped ride-sharing trip and offering a better rental and insurance rate based on the best driver.

According to an embodiment, the method builds a framework of a group of multiple driving candidates to select from to be a driver of a rental vehicle. The method further determines a driving score based on the collected set of data and generates an aggregate ranking of each of the multiple driving candidates based on the driving score. The method further computes an insurance cost for each of the multiple driving candidates based on the driving score and calculates a vehicle rental cost and an insurance cost for each of the multiple driving candidates, based on the driving score. The method further ranks each of the multiple driving candidates based on the respective calculated vehicle rental cost and insurance cost and recommends a highest ranked candidate as the best driver to receive the best vehicle rental and insurance costs.

A computer program product, according to an embodiment of the invention, includes a non-transitory tangible storage device having program code embodied therewith. The program code is executable by a processor of a computer to perform a method. The method builds a framework of a group of multiple driving candidates to select from to be a driver of a rental vehicle. The method further determines a driving score based on the collected set of data and generates an aggregate ranking of each of the multiple driving candidates based on the driving score. The method further computes an insurance cost for each of the multiple driving candidates based on the driving score and calculates a vehicle rental cost and an insurance cost for each of the multiple driving candidates, based on the driving score. The method further ranks each of the multiple driving candidates based on the respective calculated vehicle rental cost and insurance cost and recommends a highest ranked candidate as the best driver to receive the best vehicle rental and insurance costs.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method builds a framework of a group of multiple driving candidates to select from to be a driver of a rental vehicle. The method further determines a driving score based on the collected set of data and generates an aggregate ranking of each of the multiple driving candidates based on the driving score. The method further computes an insurance cost for each of the multiple driving candidates based on the driving score and calculates a vehicle rental cost and an insurance cost for each of the multiple driving candidates, based on the driving score. The method further ranks each of the multiple driving candidates based on the respective calculated vehicle rental cost and insurance cost and recommends a highest ranked candidate as the best driver to receive the best vehicle rental and insurance costs.

### BRIEF DESCRIPTION OF THE DRAWINGS

FIG. 1 depicts a diagram graphically illustrating the hardware components of intelligent best driver recommendation computing environment 200 and a cloud computing environment, in accordance with an embodiment of the present invention.

FIG. 2 illustrates intelligent best driver recommendation computing environment 200, in accordance with an embodiment of the present invention.

FIG. 3 is a flowchart illustrating the operation of intelligent best driver recommendation assistant 220 of FIG. 2, in accordance with an embodiment of the present invention.

### DETAILED DESCRIPTION

Non-owner and ridesharing insurance are new and popular businesses. A consumer may buy temporary auto insurance to drive non-owned vehicles. Additionally, consumers may buy short-term insurance ranging from several days to several months.

Nowadays, various people may be offered different car insurance rates, on temporary instances of coverage, according to multiple factors and individualized characteristics.

Currently, in the ridesharing business, there is no efficient way to determine a best driver from a group of people and assign a car to the best driver with a discounted insurance rate.

The present invention discloses a method for recommending a best driver, amongst a group of potential vehicle drivers, to get best vehicle rental and insurance costs.

Hereinafter, exemplary embodiments of the present invention will be described in detail with reference to the attached drawings.

The present invention is not limited to the exemplary embodiments below but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

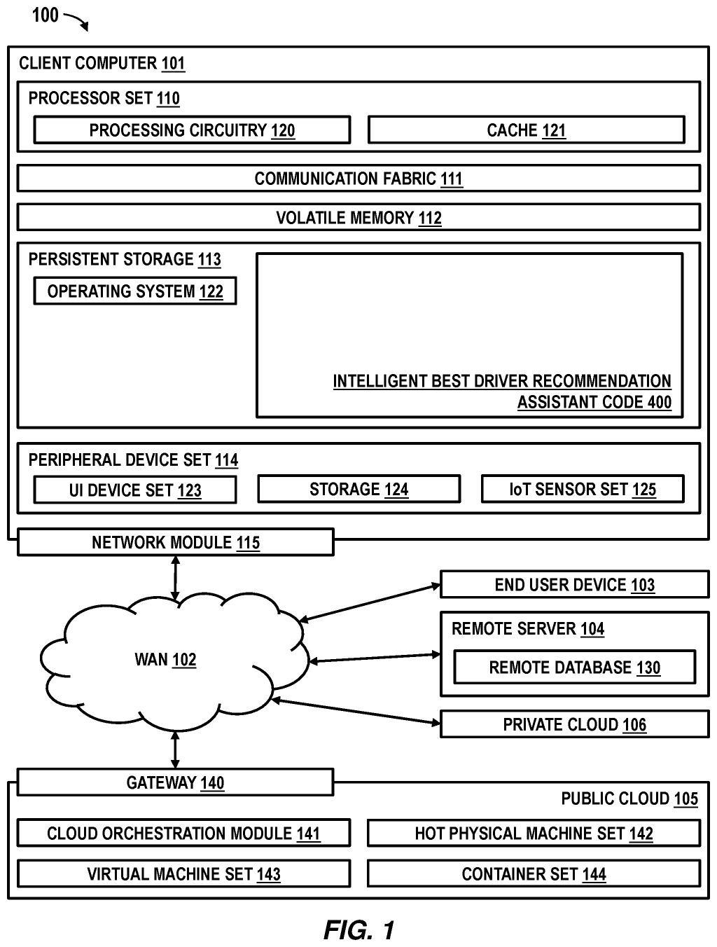

FIG. 1 depicts a diagram graphically illustrating the hardware components of intelligent best driver recommendation computing environment 200 and a cloud computing environment in accordance with an embodiment of the present invention.

Intelligent best driver recommendation computing environment 200 includes an example of an environment for the execution of at least some of the computer code involved in performing the inventive methods, such as intelligent best driver recommendation assistant code 400. In addition to intelligent best driver recommendation assistant code 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and intelligent best driver recommendation assistant code 400, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in intelligent best driver recommendation assistant code 400 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in intelligent best driver recommendation assistant code 400 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

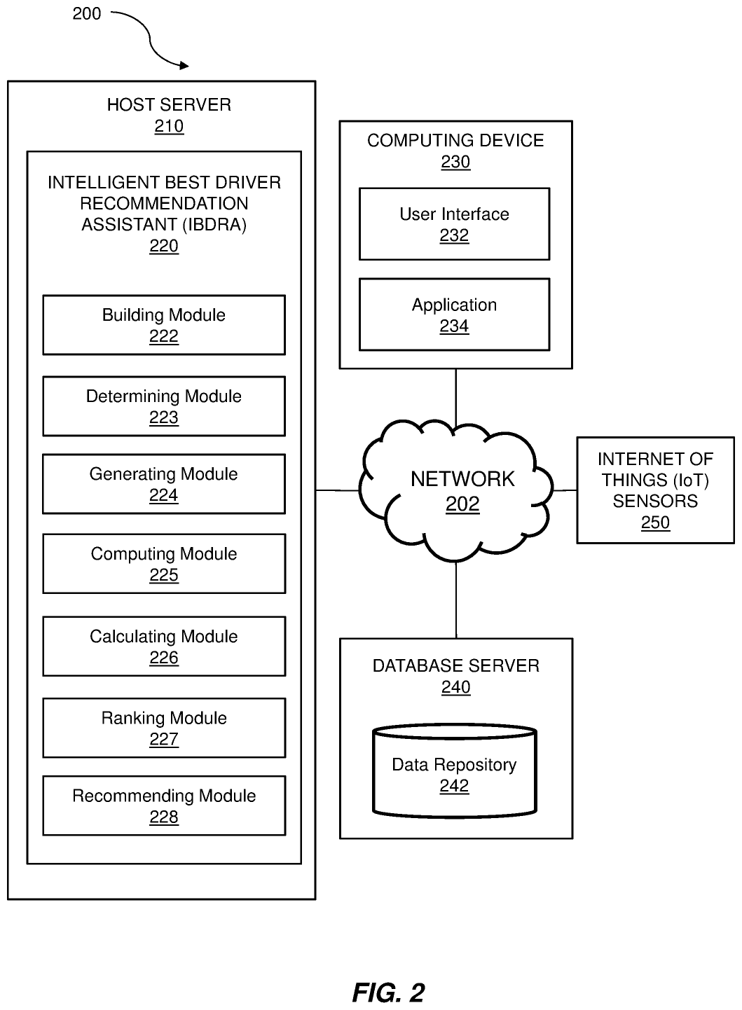

FIG. 2 illustrates intelligent best driver recommendation computing environment 200, in accordance with an embodiment of the present invention. Intelligent best driver recommendation computing environment 200 includes host server 210, computing device 230, database server 240, and internet of things (IoT) sensors 250, all connected via network 202. The setup in FIG. 2 represents an example embodiment configuration for the present invention and is not limited to the depicted setup to derive benefit from the present invention.

In an exemplary embodiment, host server 210 includes intelligent best driver recommendation assistant 220. In various embodiments, host server 210 may be a laptop computer, tablet computer, netbook computer, personal computer (PC), a desktop computer, a personal digital assistant (PDA), a smart phone, or any programmable electronic device capable of communicating with computing device 230, database server 240, and Internet of Things (IoT) sensors 250, via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing it to communicate with computing device 230, database server 240, IoT sensors 250, and other computers or servers over network 202.

With continued reference to FIG. 2, computing device 230 includes user interface 232 and application 234 and may be a laptop computer, tablet computer, netbook computer, personal computer (PC), a desktop computer, a personal digital assistant (PDA), a smart phone, or any programmable electronic device capable of communicating with host server 210, database server 240, and IoT sensors 250, via network 202. Computing device 230 may include internal and external hardware components, as depicted, and described in further detail below with reference to FIG. 1. In other embodiments, computing device 230 may be implemented in a cloud computing environment, as described in relation to FIG. 1, herein.

In exemplary embodiments, user interface 232 is a computer program which allows a user to interact with computing device 230 and other connected devices via network 202. For example, user interface 232 may be a graphical user interface (GUI). In addition to comprising a computer program, user interface 232 may be connectively coupled to hardware components, such as those depicted in FIG. 1, for receiving user input. In an exemplary embodiment, user interface 232 may be a web browser, however in other embodiments user interface 232 may be a different program capable of receiving user interaction and communicating with other devices.

In exemplary embodiments, application 234 may be a computer program, on user computing device 230, that can receive natural language text input of a user, which may be consolidated and analyzed by intelligent best driver recommendation assistant 220 on host server 210. The more frequently, consistently, and accurately a user interacts with application 234, the more genuine of a measurement of individualized characteristics of a user, related to driving safety and history patterns (e.g., driving hours, areas traveled, traffic conditions, stress/anxiety levels in various driving conditions, traffic violations received, etc.), may be obtained.

With continued reference to FIG. 2, database server 240 comprises data repository 242 and may be a laptop computer, tablet computer, netbook computer, personal computer (PC), a desktop computer, a personal digital assistant (PDA), a smart phone, or any programmable electronic device capable of communicating with host server 210, computing device 230, and IoT sensors 250 via network 202.

In exemplary embodiments, data repository 242 may contain a list of one or more users (i.e., driver candidates), together with a profile associated with each user. The individual user profile may include driving history, vehicle rental history, vehicle insurance rates, traffic violations associated with a user, health/medication data, driving record in various road/weather conditions, number of driving hours, and so forth. In exemplary embodiments, individuals must opt-in, and may opt-out at any time, prior to any individualized information is obtained, tracked, and/or stored.

In exemplary embodiments, internet of things (IoT) sensors 250 may be located within the vehicle of a user, or in any other location capable of collecting data about one or more users via one or more electronic devices of the user, such as user computing device 230. IoT sensors 250 may include embedded computing systems that allow objects, such as user computing device 230, to be sensed or controlled remotely across existing network infrastructure, such as network 202, thus creating opportunities for more direct integration of the physical world into computer-based systems, and resulting in improved efficiency, accuracy, and economic benefit in addition to reduced human intervention.

In exemplary embodiments, IoT sensors 250 may be a device, hardware component, module, or subsystem capable of recording, capturing, and detecting events or changes in a user (i.e., driver) and/or a user's driving environment and sending the detected data to other electronics (e.g., host server 210), components (e.g., data repository 242), or programs (e.g., intelligent best driver recommendation assistant 220) within a system (e.g., intelligent best driver recommendation computing environment 200). In various embodiments, the detected data collected by IoT sensors 250 may be instrumental in providing feedback to intelligent best driver recommendation assistant 220.

IoT sensors 250, in exemplary embodiments, may be a software application, proximity sensor, camera, microphone, light sensor, infrared sensor, weight sensor, magnetic ring sensor, temperature sensor, tactile sensor, motion detector, optical character recognition (OCR) sensor, occupancy sensor, heat sensor, analog sensor (e.g., potentiometers, force-sensing resistors), radar, radio frequency sensor, quick response (QR) code, video camera, digital camera, lasers, gyroscopes, accelerometers, actuators, structured light systems, tracking sensors, and other devices used for measuring, detecting, recording an environment or current state of a user.

For example, IoT sensors 250 may be capable of pairing and connecting a user's sleep quality metric from a portable health monitoring device to a temporary insurance portal via intelligent best driver recommendation assistant 220.

In exemplary embodiments, IoT sensors 250 are capable of continuously monitoring, collecting, and saving collected data on a local storage or storage on a separate server (e.g., database server 240), or alternatively sending the collected data, or various selected pieces of the collected data, to intelligent best driver recommendation assistant 220.

With continued reference to FIG. 2, host server 210 includes intelligent best driver recommendation assistant 220. Host server 210 may be a laptop computer, tablet computer, netbook computer, personal computer (PC), a desktop computer, a personal digital assistant (PDA), a smart phone, or any programmable electronic device capable of communicating with computing device 230, database server 240, and IoT sensors 250 via network 202.

With continued reference to FIG. 2, intelligent best driver recommendation assistant 220, in an exemplary embodiment, may be a computer application on host server 210 that contains instruction sets, executable by a processor. The instruction sets may be described using a set of functional modules. In exemplary embodiments, intelligent best driver recommendation assistant 220 may receive input from computing device 230, database server 240, and IoT sensors 250 over network 202. In alternative embodiments, intelligent best driver recommendation assistant 220 may be a computer application on computing device 230, or a standalone program on a separate electronic device.

With continued reference to FIG. 2, the functional modules of intelligent best driver recommendation assistant 220 include building module 222, determining module 223, generating module 224, computing module 225, calculating module 226, ranking module 227, and recommending module 228.

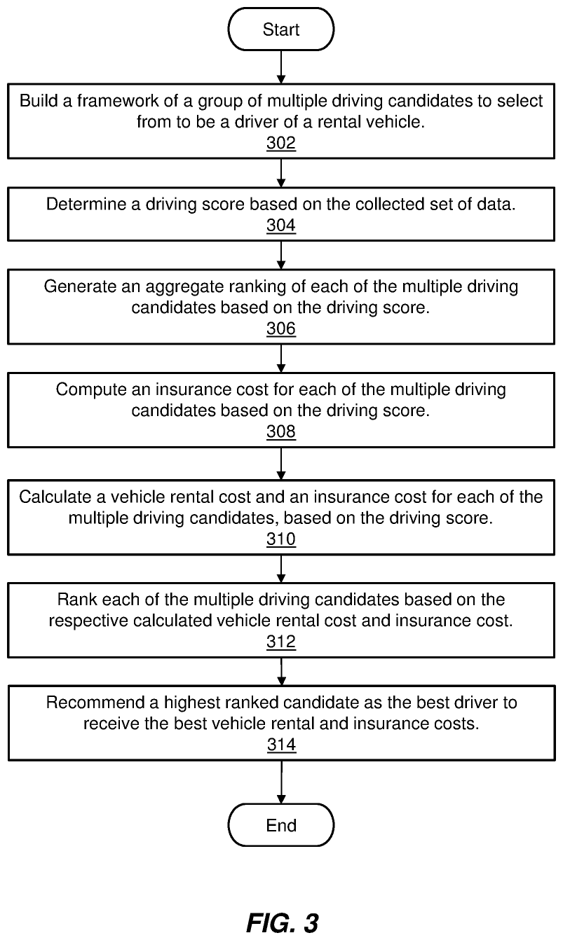

FIG. 3 is a flowchart illustrating the operation of intelligent best driver recommendation assistant 220 of FIG. 2, in accordance with embodiments of the present disclosure.

With reference to FIGS. 2 and 3, building module 222 includes a set of programming instructions, in intelligent best driver recommendation assistant 220, to build a framework of a group of multiple driving candidates to select from to be a driver of a rental vehicle (step 302). The set of programming instructions is executable by a processor.

In exemplary embodiments, an array of potential driving candidates is obtained. The array of potential driving candidates may be a plurality of friends and family members.

In exemplary embodiments, building module 222 collects a set of data for each of the multiple driving candidates, wherein the set of data comprises individualized characteristics related to driving safety and history.

Further, building module 222 defines a set of criteria for dynamically evaluating each of the multiple driving candidates, based on their respective individualized characteristics.

In exemplary embodiments, the set of criteria for dynamically evaluating each of the multiple driving candidates comprises at least one of the following: health data, medication data, driving history in various road and weather conditions, number of years of driving experience, type of car, past and current vehicle insurance rates, history of any vehicle-related accidents, and history of traffic violation tickets.

With reference to an illustrative example, Joe and his friends took a ski vacation to Colorado for a week and are interested in renting a car during their stay. Joe has downloaded the intelligent best driver recommendation assistant 220 application on his computing device 230 so he and his friends can determine who would get the best overall savings on the car rental and insurance costs. Joe and his friends are already subscribers to the intelligent best driver recommendation assistant 220 application. As such, Joe and his friends already have user profiles with data related to each person's driving record and history. Joe enters his friends' names and user identifications (ID) to build a framework of driving candidates to select from to be a driver of the car rental for the current transaction. Building module 222 collects the relevant data for Joe and each of his friends, according to their user profiles. For example, Joe has a history of driving more safely in the snow than his friend Arthur and Daniel. However, Arthur has a history of driving more safely in the rain than Joe and Daniel. Other factors, however, may be taken into consideration such as the fact that Joe is 65 years old and takes prescription medication while Arthur and Daniel are both 50 years old and do not take any prescription medications.

With continued reference to FIGS. 2 and 3, determining module 223 includes a set of programming instructions in intelligent best driver recommendation assistant 220, to determine a driving score based on the collected set of data (step 304). The set of programming instructions is executable by a processor.

In exemplary embodiments, determining module 223 utilizes a scoring system to assign a driving score to each of the multiple driving candidates based on the collected set of data. For example, a scoring system may assign a perfect score of “10” to a driver who has no prior incidents of accidents driving in the snow, for that category. In another category, the same driver may be assigned a “3” for having a history of speeding tickets. In yet another category, the same driver may be assigned a “4” due to a history of dozing off for a few seconds while driving late at night.

In exemplary embodiments, the multiple categories of assigned scores for each of the multiple driving candidates are combined to formulate a total driving score for each candidate.

With continued reference to the illustrative example above, Joe and his friends are each assigned a driving score based on their respective user profiles. Considering all categories of contributing factors, Joe is assigned a total driving score of 31, Arthur a total driving score of 38, and Daniel a total driving score of 39.

With continued reference to FIGS. 2 and 3, generating module 224 includes a set of programming instructions in intelligent best driver recommendation assistant 220, to generate an aggregate ranking of each of the multiple driving candidates based on the driving score (step 306). The set of programming instructions is executable by a processor.

In exemplary embodiments, once all factors are taken into consideration (e.g., weather, driving history, age, medications, etc.), for each of the multiple driving candidates, an aggregate ranking of the multiple driving candidates is generated.

In exemplary embodiments, the attributes of each of the multiple driving candidates may be assessed in real time.

With continued reference to the illustrative example above, the aggregate ranking for Joe, Arthur, and Daniel is in the following order: Daniel 39, Arthur 38, and Joe 31.

With continued reference to FIGS. 2 and 3, computing module 225 includes a set of programming instructions in intelligent best driver recommendation assistant 220, to compute an insurance cost for each of the multiple driving candidates based on the driving score (step 308). The set of programming instructions is executable by a processor.

In exemplary embodiments, intelligent best driver recommendation assistant 220 can access current insurance rates and discounts via an internal agent or via an intelligent best driver recommendation assistant 220 server that manages vehicle insurance information in real time, taking into accounts various rates with multiple insurance carriers.

In alternative embodiments, intelligent best driver recommendation assistant 220 can define a quantitative scoring model based on each of the multiple driving candidates driving behavior in various conditions (e.g., traffic congestion).

Certain locations may carry certain positive or negative weighting for various drivers. For example, certain drivers may be excellent drivers when conditions are ideal but become fearful drivers when it begins raining or they become stressed-out drivers when there is traffic congestion. This locational factoring can be defined, calculated with a qualitative factoring to define a quantitative scoring model.

With continued reference to the illustrative example above, computing module 225 utilizes the driving score for Joe and his friends and applies this score to prevailing insurance rates. Daniel has the best aggregate score, totaling 39 and is presumed to be able to obtain the best insurance rate. However, various factors may be weighted more than others, depending on the location of the car rental. For example, even though Daniel may be the best driver in the snow this factor is meaningless when rated in a geographic location with no snowfall.

With continued reference to FIGS. 2 and 3, calculating module 226 includes a set of programming instructions in intelligent best driver recommendation assistant 220, to calculate a vehicle rental cost and an insurance cost for each of the multiple driving candidates, based on the driving score (step 310). The set of programming instructions is executable by a processor.

In exemplary embodiments, calculating module 226 can calculate best vehicle rental rates and insurance costs according to each of the multiple driving candidates' characteristics and driving score.

In alternative embodiments, intelligent best driver recommendation assistant 220 can pair and connect each of the multiple driving candidates sleep quality metrics, from one or more IoT devices, or sensors, to an insurance portal and generate a better daily rate for vehicle and insurance costs based on greater sleep quality metrics amongst each of the multiple driving candidates.

In further alternative embodiments, a next day's rental and insurance rate would be based on new incoming data from a previous night's sleep quality metrics.

With continued reference to the illustrative example above, Joe and his friends' potential vehicle rental and insurance costs are adjusted based on their respective sleep quality metrics from the previous night's sleep. Although Daniel has the best aggregated driving score, he did not get a good night's sleep last night. Unfortunately, Daniel only slept for 3 hours, and this factor has negatively influenced the calculated insurance cost for him. Joe had a great 9-hour uninterrupted sleep last night and has heavily weighted him to be a contender for the best vehicle rental and insurance rate.

With continued reference to FIGS. 2 and 3, ranking module 227 includes a set of programming instructions in intelligent best driver recommendation assistant 220, to rank each of the multiple driving candidates based on the respective calculated vehicle rental cost and insurance cost (step 312). The set of programming instructions is executable by a processor.

In exemplary embodiments, intelligent best driver recommendation assistant 220 defines a data structure to aggregate and rank each of the multiple driving candidates' attributes in real time. For example, the data structure may comprise the following dataset [VehicleID, RegionID, CurrentTime, CurrentWeatherCondition, DrivingCandidateList, InsuranceAccountList, IBDRA_ScoreList, BestDriverID, BestRentalRate, BestInsuranceRate].

In alternative embodiments, ranking module 227 can correlate additional factors such as people's stress levels, current health indicators, intoxicating substance consumption, and so forth for additional insurance rewards and incentives.

In various alternative embodiments, intelligent best driver recommendation assistant 220 can provide an opportunity for people to understand the financial impact (on insurance costs) based on current decisions being made. For example, drivers can weigh the consequences of their actions on potential insurance quotes, prior to making decisions. Through this pro-active and predictive approach, a user can utilize the data and metadata to their collective benefit.

With continued reference to the illustrative example above, ranking module 227 ranks Joe and his friends based on calculated vehicle rental cost and insurance cost. Taking into consideration Joe and his friends' potential vehicle rental and insurance costs, Joe and Arthur are ranked at the top of the list while Daniel is in third place due to his lack of sleep metrics. However, if Daniel gets an 8-hour+ night's sleep tonight then he would be ranked before Joe and Arthur tomorrow.

With continued reference to FIGS. 2 and 3, recommending module 228 includes a set of programming instructions in intelligent best driver recommendation assistant 220, to recommend a highest ranked candidate as the best driver to receive the best vehicle rental and insurance costs (step 314). The set of programming instructions is executable by a processor.

In exemplary embodiments, recommending module 228 notifies the insurer of the best driver to adjust and apply additional best rates and incentives.

In alternative exemplary embodiments, recommending module 228 can charge a shared vehicle rental and insurance costs amongst the best driver and each of the other multiple driving candidates, according to a predefined payment agreement.

With continued reference to the illustrative example above, recommending module 228 recommends Arthur as the best driver and offers him the best vehicle rental and insurance costs. By using the intelligent best driver recommendation assistant 220, Joe and his friends were able to determine the best driver for the best savings amongst the group of friends. The costs for the car rental and insurance are split evenly between Joe, Arthur, and Daniel according to a predefined payment agreement.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, computing device 230, database server 240, and IoT sensors 250.

1. A computer-implemented method for recommending a best driver, amongst a group of potential vehicle drivers, to get best vehicle rental and insurance costs, the method comprising:
building a framework of a group of multiple driving candidates to select from to be a driver of a rental vehicle;
determining a driving score based on the collected set of data;
generating an aggregate ranking of each of the multiple driving candidates based on the driving score;
computing an insurance cost for each of the multiple driving candidates based on the driving score;
calculating a vehicle rental cost and an insurance cost for each of the multiple driving candidates, based on the driving score;
ranking each of the multiple driving candidates based on the respective calculated vehicle rental cost and insurance cost; and
recommending a highest ranked candidate as the best driver to receive the best vehicle rental and insurance costs.

2. The computer-implemented method of claim 1, further comprising:
collecting a set of data for each of the multiple driving candidates, wherein the set of data comprises individualized characteristics related to driving safety and history; and
defining a set of criteria for dynamically evaluating each of the multiple driving candidates, based on their respective individualized characteristics.

3. The computer-implemented method of claim 2, wherein the set of criteria for dynamically evaluating each of the multiple driving candidates comprises at least one of the following: health data, medication data, driving history in various road and weather conditions, number of years of driving experience, type of car, past and current vehicle insurance rates, history of any vehicle-related accidents, and history of traffic violation tickets.

4. The computer-implemented method of claim 1, further comprising:
charging shared vehicle rental and insurance costs amongst the best driver and each of the other multiple driving candidates, according to a predefined payment agreement.

5. The computer-implemented method of claim 1, further comprising:
notifying insurer of the best driver to adjust and apply additional best rates and incentives.

6. The computer-implemented method of claim 1, further comprising:
pairing and connecting each of the multiple driving candidates sleep quality metrics, from one or more internet of things (IoT) devices to an insurance portal; and
generating a better daily rate for vehicle and insurance costs based on greater sleep quality metrics amongst each of the multiple driving candidates.

7. The computer-implemented method of claim 1, further comprising:
defining a quantitative scoring model based on each of the multiple driving candidates driving behavior in traffic congestion.

8. A computer program product for implementing a program that manages a device, comprising a non-transitory tangible storage device having program code embodied therewith, the program code executable by a processor of a computer to perform a method, the method comprising:
building a framework of a group of multiple driving candidates to select from to be a driver of a rental vehicle;
determining a driving score based on the collected set of data;
generating an aggregate ranking of each of the multiple driving candidates based on the driving score;
computing an insurance cost for each of the multiple driving candidates based on the driving score;
calculating a vehicle rental cost and an insurance cost for each of the multiple driving candidates, based on the driving score;
ranking each of the multiple driving candidates based on the respective calculated vehicle rental cost and insurance cost; and
recommending a highest ranked candidate as the best driver to receive the best vehicle rental and insurance costs.

9. The computer program product of claim 8, further comprising:
collecting a set of data for each of the multiple driving candidates, wherein the set of data comprises individualized characteristics related to driving safety and history; and
defining a set of criteria for dynamically evaluating each of the multiple driving candidates, based on their respective individualized characteristics.

10. The computer program product of claim 9, wherein the set of criteria for dynamically evaluating each of the multiple driving candidates comprises at least one of the following: health data, medication data, driving history in various road and weather conditions, number of years of driving experience, type of car, past and current vehicle insurance rates, history of any vehicle-related accidents, and history of traffic violation tickets.

11. The computer program product of claim 8, further comprising:
charging shared vehicle rental and insurance costs amongst the best driver and each of the other multiple driving candidates, according to a predefined payment agreement.

12. The computer program product of claim 8, further comprising:
notifying insurer of the best driver to adjust and apply additional best rates and incentives.

13. The computer program product of claim 8, further comprising:
pairing and connecting each of the multiple driving candidates sleep quality metrics, from one or more internet of things (IoT) devices to an insurance portal; and
generating a better daily rate for vehicle and insurance costs based on greater sleep quality metrics amongst each of the multiple driving candidates.

14. The computer program product of claim 8, further comprising:
defining a quantitative scoring model based on each of the multiple driving candidates driving behavior in traffic congestion.

15. A computer system for implementing a program that manages a device, comprising:
one or more computer devices each having one or more processors and one or more tangible storage devices; and a program embodied on at least one of the one or more storage devices, the program having a plurality of program instructions for execution by the one or more processors, the program instructions comprising instructions for:
building a framework of a group of multiple driving candidates to select from to be a driver of a rental vehicle;
determining a driving score based on the collected set of data;
generating an aggregate ranking of each of the multiple driving candidates based on the driving score;
computing an insurance cost for each of the multiple driving candidates based on the driving score;
calculating a vehicle rental cost and an insurance cost for each of the multiple driving candidates, based on the driving score;
ranking each of the multiple driving candidates based on the respective calculated vehicle rental cost and insurance cost; and
recommending a highest ranked candidate as the best driver to receive the best vehicle rental and insurance costs.

16. The computer system of claim 15, further comprising:
collecting a set of data for each of the multiple driving candidates, wherein the set of data comprises individualized characteristics related to driving safety and history; and
defining a set of criteria for dynamically evaluating each of the multiple driving candidates, based on their respective individualized characteristics.

17. The computer system of claim 16, wherein the set of criteria for dynamically evaluating each of the multiple driving candidates comprises at least one of the following: health data, medication data, driving history in various road and weather conditions, number of years of driving experience, type of car, past and current vehicle insurance rates, history of any vehicle-related accidents, and history of traffic violation tickets.

18. The computer system of claim 15, further comprising:
charging shared vehicle rental and insurance costs amongst the best driver and each of the other multiple driving candidates, according to a predefined payment agreement.

19. The computer system of claim 15, further comprising:
notifying insurer of the best driver to adjust and apply additional best rates and incentives.

20. The computer system of claim 15, further comprising:
pairing and connecting each of the multiple driving candidates sleep quality metrics, from one or more internet of things (IoT) devices to an insurance portal; and
generating a better daily rate for vehicle and insurance costs based on greater sleep quality metrics amongst each of the multiple driving candidates.
